(19) United States
(12) Patent Application Publication
(10) Pub. No.: US 2006/0240384 A1
(43) Pub. Date: Oct. 26, 2006

(54) Dental implant with an integral structure comprising a stump completely or partially realized in advance

(76) Inventor: Maurizio Fraccon, Roma (IT)

Correspondence Address: YOUNG & THOMPSON, 745 SOUTH 23RD STREET, 2ND FLOOR, ARLINGTON, VA, 22202, US

(21) Appl. No.: 10/567,744

(22) PCT Filed: Feb. 6, 2004
(86) PCT No.: PCT/IT04/00045

§ 371 Date: Feb. 10, 2006

(30) Foreign Application Priority Data
Aug. 12, 2003 (IT) RI2003A000008

(51) Int. Cl. A61C 8/00

(52) U.S. Cl. 433/173

(57) ABSTRACT

A single-phase dental plant with a single structure including a stump realized in advance, or partially realized in advance, that may be personalized and applied during one single surgical visit; consisting of one single structure and united to the body of the plant to be inserted into the bone-called fixture-already during making, so as to be filed immediately after the operation directly in the mouth of the patient straight away, or after having reconstructed the intra-oral stump, thus resulting suitable for the correct insertion of the prosthesis. The truncate-cone shape-called abutment-of the stump inserted in the fixture, in the full variant, allows to model, directly in the mouth of the patient with a preparation cutter mounted onto a turbine, a stump provided with the correct inclination of the correct prosthesis rehabilitation, while the shell of the hollow variant, allows the dentist to personalize the stump.

The present invention concerns a dental plant complete with a stump realized in two variants: realized in advance in the full variant, or partially realized in the hollow variant, so as to make it completely personalized and suitable for being applied in one single surgical visit: in-fact, being out of one single structure, no further surgical re-entry is expected. Said stump realized in advance is united to the body of the plant that will be inserted into the bone, usually called ‘fixture’ since realization and may be filed immediately after the surgical operation already in the mouth of the patient: immediately in the full variant and after the reconstruction of the intra-oral stump in the hollow variant. According to the present invention, a stump may be obtained suitable for the correct insertion of a prosthesis: in fact, it is due to the shape of a truncated cone—called ‘abutment’—of the stump inserted into said fixture—in the full variant—that it will be possible to shape, directly in the mouth and with the help of a preparation cutter mounted onto a turbine, a stump having the correct inclination for the correct prosthesis rehabilitation.

Furthermore, the funnel-shaped shell of the trans-mucous part of the stump, in the hollow variant, allows the dentist to personalize the stump, realizing it with a pin out of zirconium fibre and with a polimerized compound safe from fluids, due to just said funnel shape that insulated them from the mucous membrane, so as to obtain a stump with the desired inclination in the desired moment; in the hollow variant, the plant may be partially covered for the time desired, just surfacing from the mucous membrane and thus behaving like a trans-mucous plant. Furthermore, once the stump has been filed, it may be obtained that said stump has an axis coinciding or angled with respect to the one of the fixture, according to the needs. Therefore, it will be easy, in the presence of a good primary stability, to construct and cement in the same visit a provisional tooth or a definitive crown (it is suggested to make use of compound or baked clay).

For what concerns the art known up to now, the plants are prosthesis' out of titanium inserted into the bone for replacing or imitating the functions of the missing root of natural teeth. Onto said plant, a prosthesis crown is built in a prosthetic process. Essential condition for performing the implantology is the presence of bone sufficient for their integration with said bone. If there is too little bone, there are a series of techniques provided for bone regeneration.

In the presence of an edentate bony crest with a bone sufficient in quality and quantity, the plant may be inserted after having prepared a periosteal-mucus border or an operculum; now, a hole is performed in the cortical and a housing suitable to the shape of the plant that is to be inserted, mainly cylindrical or conical, with special cutters and under abundant irrigation or with special osteotomy. The fixture gets inserted by screwing in the prepared channel, in the case of screw plants, after tapping—if the kind of plant provides it—and after having disassembled the possibly present ‘mouth’, the head of the plant is closed with a sort of cap screw. In the case of impact plants, the insertion takes place by means of little strokes with special instruments. It will be tried to position the head of the plant, where the cap screw will be screwed, in that aera that allows the best aesthetic and functional results, and the latter often will coincide with the edge of the bony crest. The area will be washed and the border sewed or, in the case of an operculum, the plant will be left open, or it will be protected with substances like calcium sulphate or collagen.

In the case of a post-extraction plant, the tooth or the dental root is pulled out and immediately the plant is inserted, after having prepared the site with special cutters mounted onto a strick and fisiodispenser, or by osteotomy. It will be tried to adjust the shape of the alveolus and to get lower beyond the alveolus so as to assure the primary retention, which is an essential requirement for the success of the plant.

It will be tried to insert the plant in the shape the most similar to the shape of the dental root that is to be prosthetically replaced.

Should the bone be insufficient, it will be necessary to turn to vertical and horizontal bone regeneration techniques, like split crest, the use of membranes, grafts with alloplastic materials or taking of the bone, etc.

If the bone is sufficient in quantity and quality, the insertion can be performed immediately; otherwise, it is good to leave the plant covered and later on perform a surgical re-entry—two to six months later—for inserting the recovery screw that conditions the recovering of the mucosa or the stump directly.

Now the imprint is taken with transferts and laboratory homologous', that may reproduce the same position of the fixture on the models. In the laboratory, a special stump will be prepared with different methods—filed and pre-shaped, that may be calcined . . . The technician will realize also the structure of the crown—if it is a crown out of metal and baked clay or metal and resin—that will be covered with baked clay or resin, or even the complete crown, if that crown is out of resin, compound or other compatible materials. Once the different tests have been performed in the mouth of the patient, the stump will be cemented or screwed—if the stump is to be cemented or screwed—and its inner hollow space will be filled with some compound and the crown will be cemented with suitable material. Also the screwed prosthesis may be used, as it is easier to be managed should there arise any problem with the plant.

Furthermore, there are other kinds of plants, like the Tramonte screws or the AT-plants, consisting of one single piece. The correct inclination of the extra-bone part forming the stump is obtained by deforming with pliers, and directly in the mouth of the patient, the structure of the plant so that the area that works as an abutment will be parallel to the contiguous structures, for allowing the insertion of the prosthetic crown.

Most of the existing plants—with exception of those having the shape of a blade, of a tripode etc.—consist of a fixture of different possible shapes—cylindrical, conical, with variable conicity—and of a stump that may be cemented or screwed. These two parts are separately supplied and will get united after having chosen the suitable stump only in the moment the surgeon performing the plant considers well-timed, and this may be during the same visit in the case of a plant with immediate application, or later on in time in the case of plants with deferred application. The stump, or abutment, may be out of titanium or other materials, among which zirconium or the compound, pre-shaped, straight or with angles previously shaped with respect to the axis along the fixture, or that may be calcined and realizable in laboratory. Said stump will be fixed to the fixture by means of a device of the male-female kind of different shape—octagon or hexagon, internal or external, with different indentations, etc—that allows a first primary retention, increasing in a way directly proportional to its length. In the case of the screwed stump, the abutment and the fixture are kept together by a screw passing through the hollow structure inside the same. In spite of the supply of a dynamometric key for tightening the screw, it may happen that the latter loosens, mostly in the case of bruxist patients or in case of error in the gnatologic planning. This will determine a chronic movement of the abutment from which a facture of the passing-through screw, of the stump or of the same fixture may derive. This means that the weak ring of the chain is the screw: the many tests the surgeon sometimes has to perform, the insertion and the removal of the cap screw, of the screw, of the transfert, of the stump may cause the further wearing and deteriorating of the passing-through screw and of the threading inside the fixture.

It is the aim of the present invention to realize a plant consisting of one single piece—in its full and hollow variants—containing inside the fixture (that is to be inserted in the bone and that may be similar, in its outer side, to a screw fixture probably most used at present), and the stump, united already by the maker.

The installation of the plant according to the present invention comprises a new surgeon technique that provides the access to the bone without the preparation of a border, but due to the realization of an operculum performed with a radio-scalpel, a mucotomous, a blade scalpel by means of which a holecan be performed in the bone with a cutter mounted on strick on fisiodispenser or with osteotomy and/or different scalpels of a dimension similar to the one of the plant to be inserted. By means of the analysis of images like Dentascan, an orto-panoramic, indooral x-rays etc., with external trans-mucous sounding, with needles, files, straight stylets etc., with an internal vision by means of illuminated optics or, even better, by means of a surgical microscope, the quantity of bone at disposal may be determined. This makes the preparation of a periosteal-mucus border useless if not even damaging because if on one side it facilitates a direct vision, on the other hand it takes away nutrition to the tissue that is to be used for the insertion of the plant. The consequence will be a worse irroration, a lacking regenerative contribution to the periosteum in the period immediate after the operation, an aesthetical damage with possible scars. When the border is prepared, also surgical errors are penalized. With the use of this technique, possible perforations or accidental fractures of the cortical may be easily repaired, because the periosteum and the soft tissue all around will remain adherent and will continue to nourish the cortical: it will be sufficient to understand the error and to insert the plant inside said perforated part, which will then repair itself. The performance itself will be facilitated also, as it will not be necessary to engage medical personnel for keeping the border lifted: sometimes it is even possible to insert the plant by oneself. This technique provides for a success rate of 100% if correctly performed, but it is in contrast with the known ones which provide that the plant must be protected by well-sutured mucosa around and over said plant. With this technique the plant may remain exposed to the oral ambient, even with various turns exposed: in fact, the coagulum of the post-operation or a calcium-sulphate compress will prevent the germs from contaminating the plant immediately after the operation. It may also happen that in some post-extractive plants the alveolus does not bleed as much as to form a considerable coagulum: the plant thus inserted will be exposed therefore of a plurality of turns and therefore it will be contaminated by the germs of the oral surrounding: a correct oral hygiene, that may be helped by washing with “chlorexidine” or other antibiotic, and an antibiotic covering will allow the complete recovering of the plant. A fundamental condition for this to happen is the primary stability of the plant. Another advantage of the technique according to the present invention is that the patient will not show a post-operation edema, nor pain and this makes unnecessary the use of cortisone: this is due to the fact that the tissues have suffered only a small trauma and that, in any case, the liquids drain: in fact, no sutures are used. This implied also reduced costs: the only alloplastic material required is calcium sulphate, which is not expensive. Furthermore, the present invention provides the application of a sheath projected in such a way that it may be divided into two parts: one that must remain sterilized until it is opened—which coincides with the moment just before the insertion of the plant—and that contains the fixture; and one that may be opened before, so as to allow the preparation of the stump contained therein in a laboratory or directly during operation.

From what described hereinabove, the advantages deriving from the present invention appear evident.

Two variants of a single-phase dental plant with a single structure comprising a stump completely or partially realized in advance, according to the present invention, will be shown hereinbelow relating to the enclosed drawings.

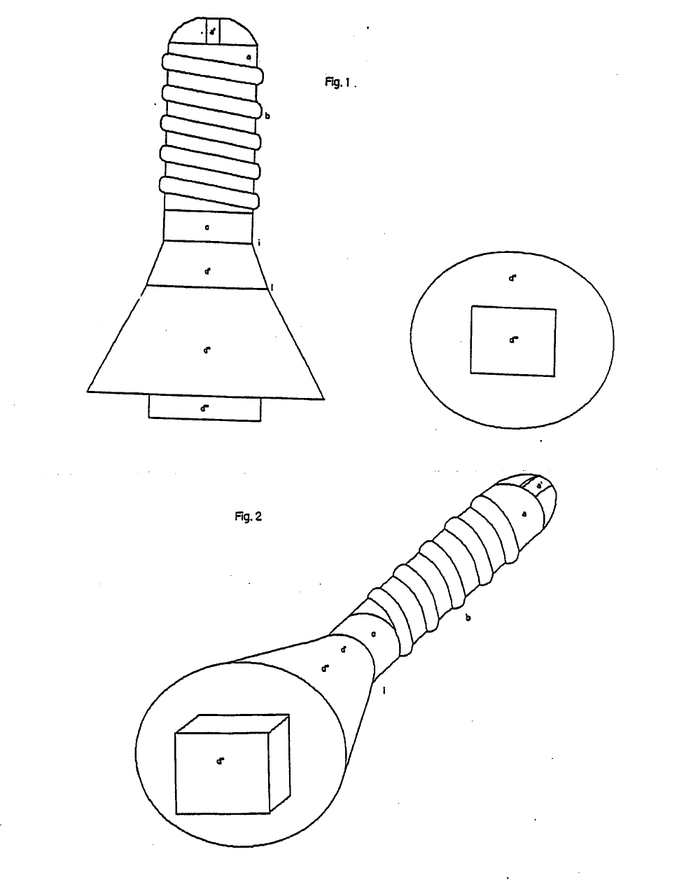

FIG. 1 shows a single-phase dental plant with a single structure comprising a stump completely or partially realized in advance, according to the present invention, with the stump already realized in the full or VP variant.

FIG. 10 shows a single-phase dental plant with a single structure comprising a stump completely or partially realized in advance, according to the present invention, in the hollow or VC variant, so as to be personalized, and shows the fixture that must be inserted into the bone.

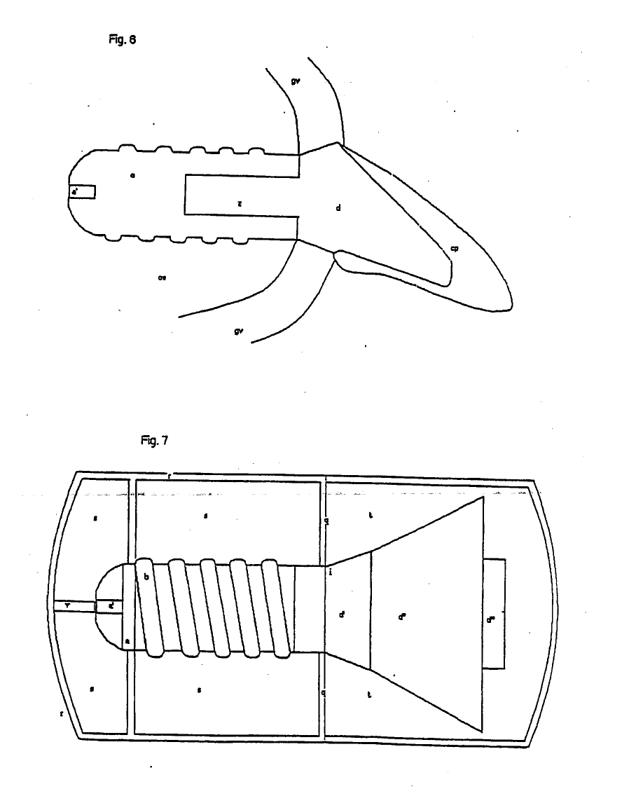

Once a stump has been obtained suitable for the correct insertion of the prosthesis, the shape of a truncated cone of the abutment in the VP allows to model, according to FIG. 4, directly in the patient's mouth with a preparation cutter mounted onto a turbine M, a stump D as shown in FIGS. 4 and 5, with the correct inclination for the correct prosthesis rehabilitation.

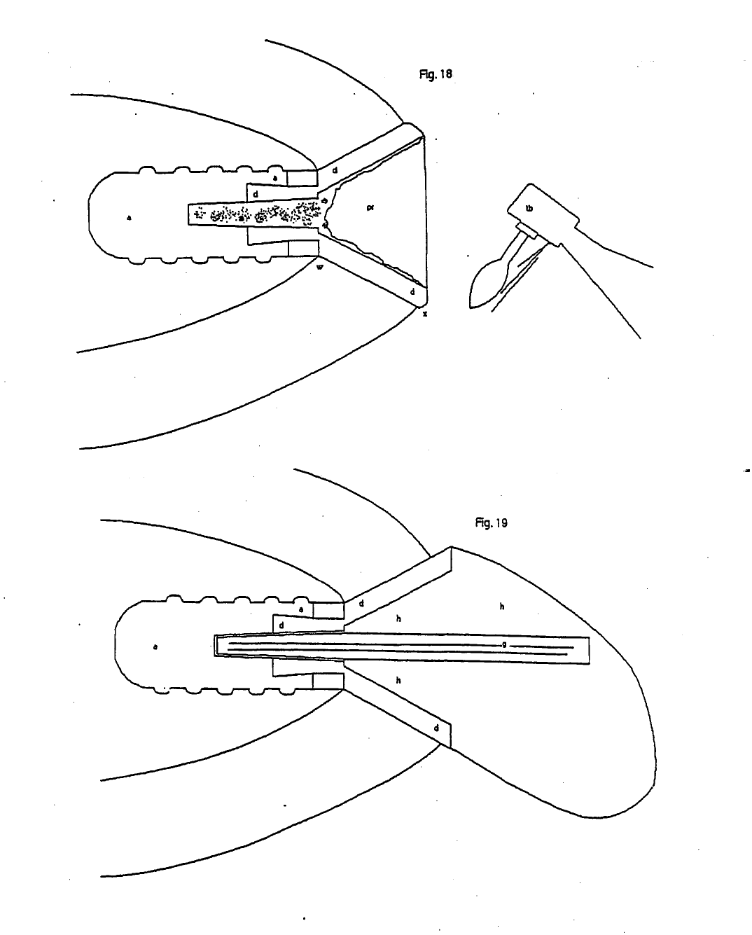

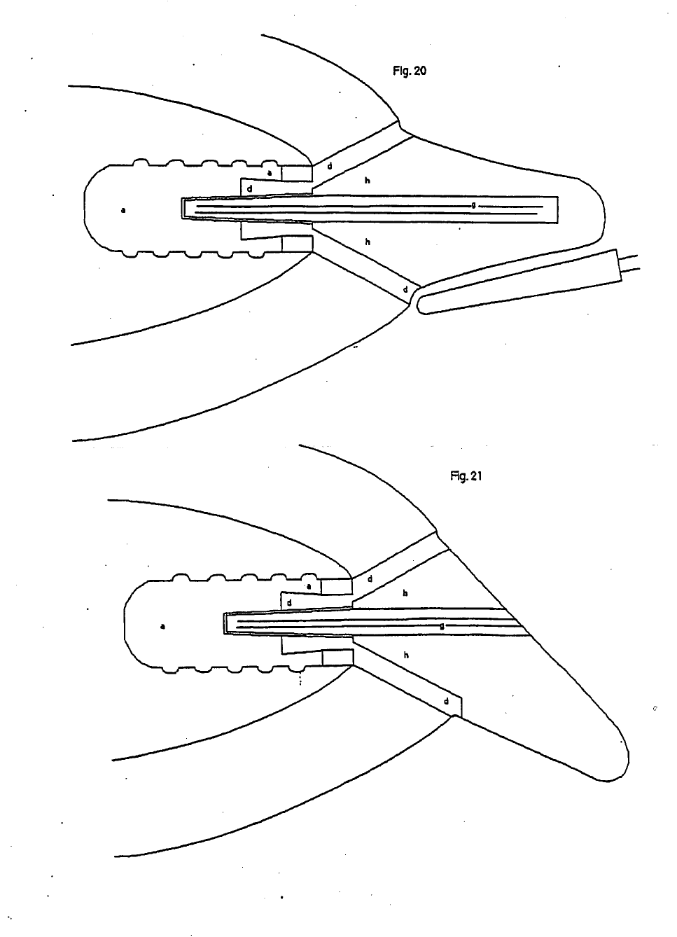

The shell in the shape of a funnel D as shown in FIG. 10 allows the dentist to personalize the stump, realizing the same with a pin G out of a zirconium fibre and a compound H as shown in FIG. 15, so as to obtain a stump with the desired inclination, as shown in FIG. 17, and in the desired moment, as in the VC the plant may remain partially covered for the time desired just surfacing from the mucosa, as shown in FIGS. 19 and 20, and thus behaving like a trans-mucous plant. Once it has been filed, a stump may be obtained having a coinciding axis as shown in FIG. 18, or edged with respect to the axis of the fixture.

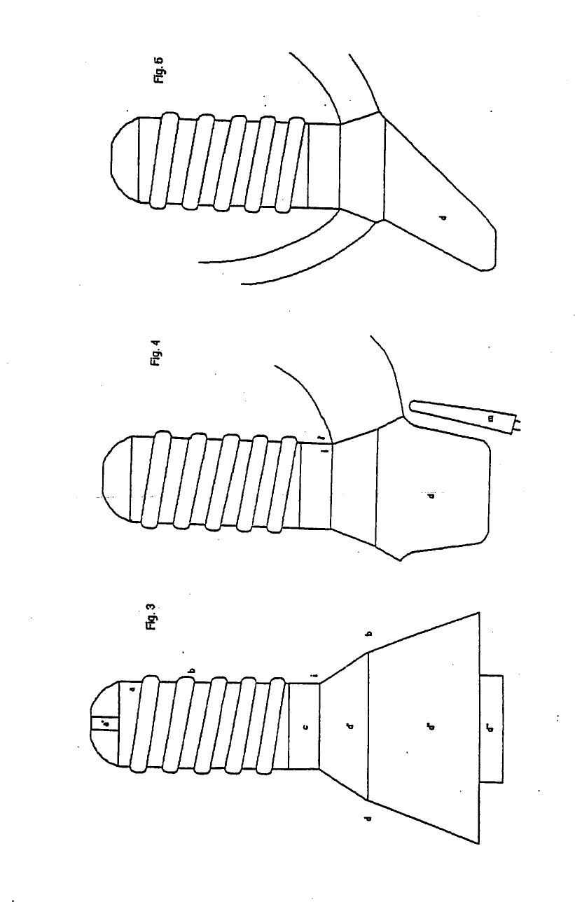

In the full variant, the fixture A if FIGS. 1 and 2 must have a cylindrical or conic shape so as to be inserted into the hole performed by the odontologist in the bone by means of special cutters, the last of which must show the shape thereof, even if slightly thinner, for allowing a primary retention of the fixture. The latter may be obtained also due to turns B shown in FIGS. 1 and 2, whereby the shape and pitch thereof may be varied and/or agreed with the maker and may be superimposed to the one of an already tested plant, until the passage area between titanium and zirconium, shown in FIGS. 1 and 2, i.e. in the limit area between the neck C of the plant and the stump D, arrives to the limit of the bony crest I. The turns are industrially treated so as to show a rough surface for improving the bone integration; the turns end in the area of the plant's neck: said area will be smooth, of variable length, preferably 2 mm long and with a cylindrical shape. The part that works as a stump in turn consists of two parts: the first part D′, defined ‘trans-mucous’, and shown in FIGS. 1, 2, 9 may be cylindrical or in the shape of a truncated-cone turned upside down; the second part D″ of the oral kind, in the shape of a truncated-cone turned upside down as shown in FIGS. 1, 2, 9. If the first one is cylindrical, it will have the same diameter of the fixture in the area of the neck and a height of about 2 mm; if it has the shape of a truncated-cone turned upside down, it will have as its smaller basis a circle, passage point between the titanium neck and this area I that will act as a trans-mucosa, and its major basis will be another, greater circle L shown in FIG. 1, that will mark the passage between the first part crossing the mucosa and the second part projecting from the oral cavity; the second part—the truncated-cone D″—will have a major conicity than the first one; the two parts may also be made in such a way that the passage is not clean but gradual, shaped with concave or convex walls; the second oral part may also have the shape of a hemisphere; the first part D′ of FIG. 1 may also be made with different heights for better encountering the functional and aesthetic needs of the implantologist: in fact, this is that part of the trans-mucous plant for which it will be easy to choose a plant with a low trans-mucous part, e.g. 1.5 mm, if the patient has a small adherent gingiva, or a higher part if the soft tissues are very thick. The second part will be preferably inserted at least haf a millimetre under the level of the mucosa, from the part of the smaller base of the truncated-cone L. The trans-mucous and extra-mucous portions may also be made—for better simulating the anatomy of the incisor teeth—with an elliptic section D′ and D″ as shown in FIG. 3, and with bio-compatible material like zirconium, with different colouring so as to better simulate the natural tooth even in the trans-mucous portion, mainly after a possible mucous recession: in this case, of course, the truncated cones turned upside down will have an elliptic shape, except for the smaller basis with which they get connected to the titanium of the circular fixture, as shown in FIGS. 2 and 3. The stump projecting in the oral cavity and that forms one single piece with the trans-mucous portion will therefore be realized out of zirconium and possibly available in the different colouration of the Vita-scale, and will have the shape of a truncated-cone turned upside-down, with the major round base having the shape of a crown more that the lower one. In any case, a structure D′″ is provided at the centre of the wider base of the upside-down truncated-cone, out of zirconium, and having a cubic shape as shown in FIGS. 1, 2, 8 and 9. Said structure D′″ has the function of a hold: as shown in FIG. 8, a small key P may be inserted and when said key gets stuck, it makes force onto the internal part of the plant allowing to move it at one's desire and therefore to screw it onto the bone. This means that the hold D′″ has a function similar to the Mounth but while the latter may be removed by unscrewing, said hold may be easily filed at the end of the visit. A fissure performed in the end of the second part of the stump may have the same function, because a screwdriver may be inserted therein for screwing the plant.

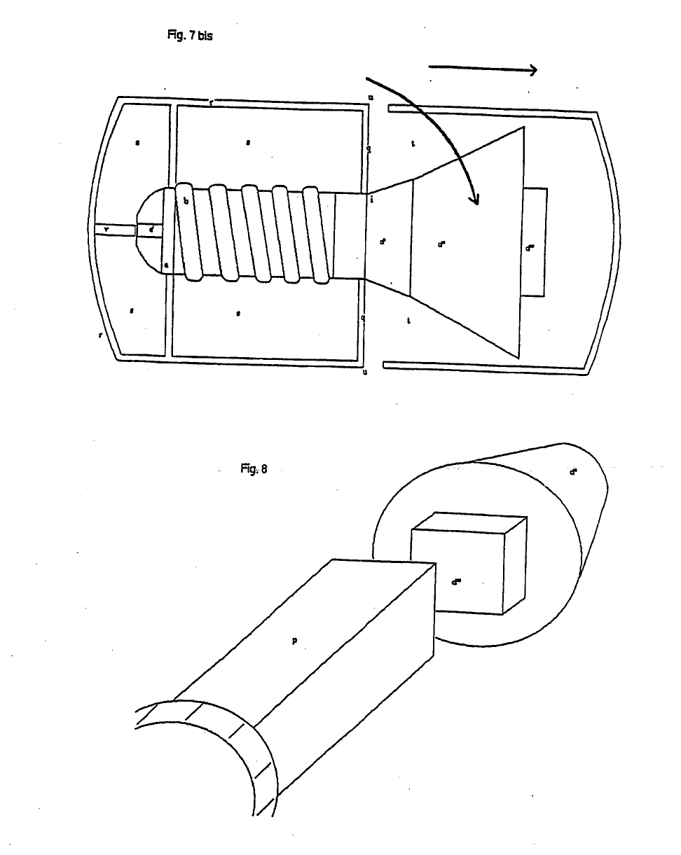

The shape of an upside-down truncated cone of the stump allows to insert the plant in the preferred position, determined by the particular functional needs and by the inclination of the bony crest: in fact, it will be possible to obtain from that upside-down truncated-cone a stump with an axis parallel to the one of the teeth nearby, after having ground them by means of the cutter M shown in FIG. 4, mounted onto the dental turbine shown in FIG. 4, or directly in the mouth of the patient. This means that it will be possible to obtain a stump with an inclination of the axis suitable for obtaining a correct prosthesis, notwithstanding the portion of the plant inside the bone has an axis with a different inclination, as shown in FIGS. 4 and 5. It won't be necessary any more to chose each time the correct stump: it will be sufficient to obtain from this stump realized in advance the stump with the desired shape, with a cutting performed directly in the mouth, in the same way as natural teeth are filed. Now the plants may be personalized, making them ever more similar to the natural teeth. Should the dentist provide, already in the implantologic project, to insert the plant in such a way that the fixture is angled with respect to the stump, it will be possible to thin the stump down in laboratory or directly in the hand, at the treatment chair with the cutter mounted on the turbine. This will be possible due to the special case shown in FIG. 7, that seals the plant so as to divide it into two parts by means of a separation membrane or structure Q, e.g. out of plastic, shown in FIG. 7, placed in the passage area between the fixture and the stump: said membrane has the function of sealing the area S of the fixture shown in FIG. 7 during the operations of thinning down, keeping it protected in its stiff case R shown in FIG. 7, having—e.g.—a cylindrical shape, keeping its sterility. The part of the case T covering the stump—shown in FIG. 7—has the purpose of keeping its sterility and safety until it must be used in the plant. At this point, the two parts of the case will be separated, making force with the hands rotating and pulling in the direction of the arrows of FIG. 7 bis, in correspondence with the area of the separation membrane that will show, near the part of the stump, a point of less resistance U shown in FIGS. 7 and 7 bis. Thus the dentist may firmly hold the plant by the case on the part of the fixture, so as to be able to file without fear the plant and without that the deposit obtained during grinding contaminate the sterilized area of the case. Furthermore, the plant may remain stable inside the case due to the support of tabs V welded to the case from the inside and out of the same material, as shown in FIG. 7, e.g. hard transparent plastic or any other cheaper material corresponding to the same functional principles: special stiffness, elasticity, transparency that allow the plant to remain stable in the working phase in the laboratory. This will be possible if they will get into contact with the fixture in three or more distal points, towards the end of the fixture, and in three or more proximal points towards the beginning of the fixture from the part of the stump. Once the extra-oral thinning down is completed, the case housing the fixture may be opened making pressure onto the same along a longitudinal line dividing it as in two halves: this area will be prepared by the maker and will be one point of less resistance for disengaging the case from the plant after having hooked the same by means of the small key P shown in FIG. 8: on the holding structure D′″. This system allows to adapt the stump even in those cases when the truncated-cone stump realized in advance proves to be too large and does not fit the area to prosthesize, e.g. if it strikes the lateral surfaces or the teeth contiguous to a post-extractive or teeth less site.

Stumps shaped and filed in advance may be realized, or more or less long stumps and stumps with a more or less pronounced conicity, so as to afford even extreme cases. If a stump must be very angled with respect to the fixture, and if said stump will prove to be very short, due to lack of space between contiguous teeth and after the grinding phase that makes it parallel to the contiguous teeth for allowing the correct insertion of the prosthesis crown, it will be possible to obtain a primary retention all the same making its lateral surfaces less conic, i.e. more parallel according to the rules of the prosthesis preparation of the stump. Furthermore, said stump may be lengthened by adding some compound at its top after having cut a small hole, with a truncated-cone diamonded cutter mounted onto a turbine that will assure a primary retention: the whole—the zirconium or compound stump and the compound added to the same—will be polished with preparation cutters.

The second part may be realized also in such a way that it consists of two upside-down truncated cones, linked one to another so that the one with the greater conicity is nearer to the fixture. This will allow the stump to be longer with respect to the inter-dental spaces: a stump consisting of one single truncated cone, the side whereof is too much angled with respect to the greater axis and must necessarily be very low for being inserted between two teeth, because otherwise it will be too large. This inconvenience may be overcome by making a stump with one or more portions of truncated cone, with a conicity decreasing while distancing from the fixture, and which allow to make it longer and, at the same time, to obtain therefrom an angled stump, after cutting. If compound crowns are used, cemented with the same kind of compound, an over-gingival Chanfer preparation may be performed: such a prosthesis will prove to be very realistic, showing a natural aspect even with trans-illumination, as there is no metal in the stump. In this way also the problems linked to bi-metallism are solved. If there is a good primary retention and a bone of good quality, the stump may be filed and an imprint may be taken for the provisional prosthesis out of resin or for the definitive prosthesis CP shown in FIG. 6, during the same visit of the surgical insertion. In the case of a compound prosthesis, the latter may be made directly after having taken the imprint, so that in about more or less two hours it may be definitely cemented, finished and polished directly in the mouth of the patient. By means of said technique it will be therefore be possible, in some cases, definitely to provide a toothless site with a prosthesis in one single solution in about three to six hours. If you should not feel sure, the truncated cone part may be used as a recovering screw, possibly filing it lightly so as to better adapt to the site and rounding the edges so that it may be well tolerated by the patient, until the recovering of the soft and/or hard tissues does not allow to load the plant.

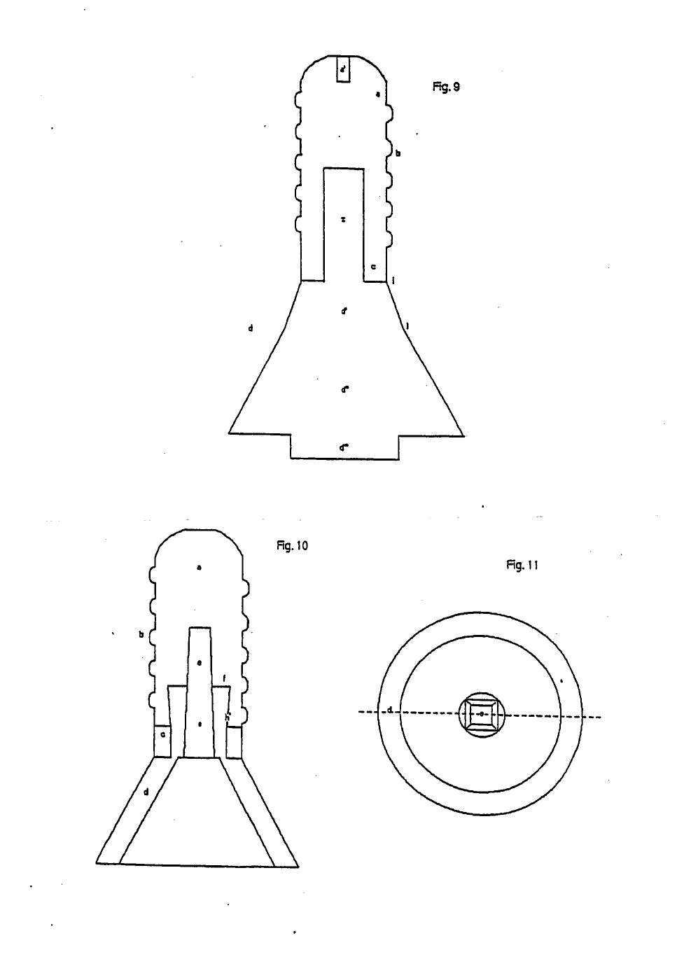

For housing the passing-through screw, it is not necessary that the fixture is hollow for fixing the stump or the cementable pin. The plant according to the present invention will not contain hollow spaces, which can become starting points for cracks, if not projected on purpose for making the structure lighter and, in any case if ever present, they should be preferably filled with light inert material, but it will be made out of titanium and zirconium without continuity solution, as shown in FIG. 9. From the outside, the fixture will be made out of titanium thus simulating, if necessary, the structure of a plant already existing, but inside the hollow area Z will be obtained as shown in FIG. 9, with a suitable shape and length as to allow the connection and the primary retention with the zirconium or compound stump. Said groove must be of the correct dimension, so as to assure, at the same time, the correct resistance of the titanium walls of the fixture. The shape of the groove may be, e.g., of an upside-down truncated cone with a small conicity, with the lower base turned towards the oral cavity and the occlusion plane.

Furthermore, the part working as a stump may be made out of titanium only or have a reinforcing titanium core.

As said plants do no longer need more than one groove inside the fixture for allowing the housing of the passing-through screw, they may be realized also thinner than the conventional plants: the plant will be very resistant all the same, because it will be full and not empty, thus avoiding the risk of a fracture. Having a smaller diameter, it will be possible to perform the insertion into very thin toothless crests without the need of making use of an operation for a bone increase.

The fixture may have a cylindrical and/or conical shape and/or the shape most suitable to the best functional result.

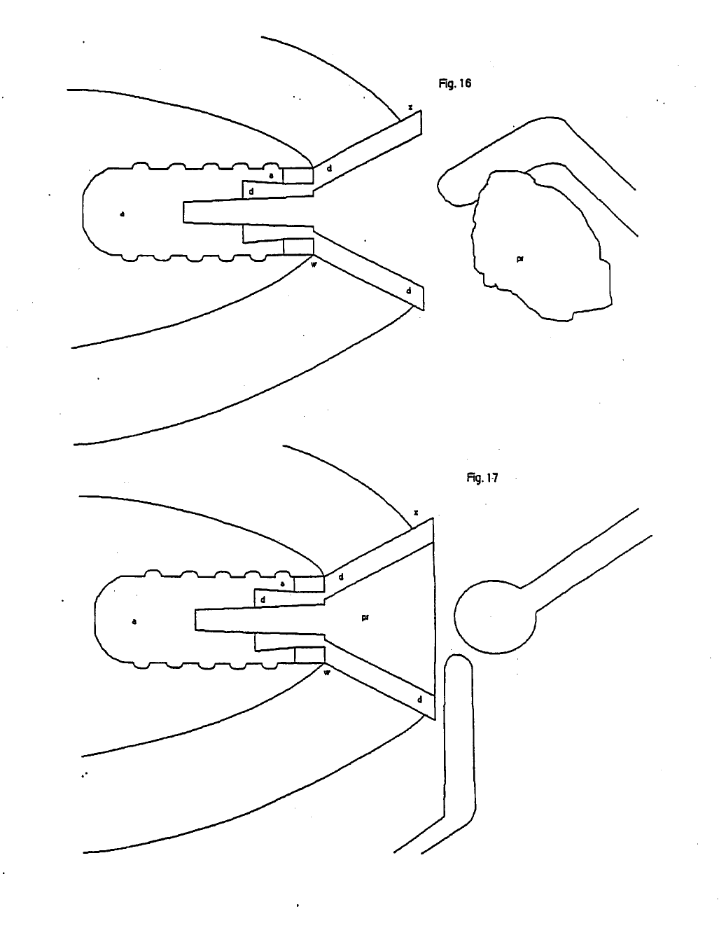

The second variant of the mono-phasic mono-block plant of the hollow kind VC consists of a plant formed by a fixture A shown in FIGS. 10, 12 and 14, and by a stump D also shown in FIGS. 10, 12, 14 out of zirconium or compound or other aesthetic and/or transparent material, similar in its external part to the above described one but hollow inside, like a funnel. This allows to insert inside the same a transparent pin G, shown in FIGS. 19, 20 and 21, e.g. out of zirconium fibre, cemented with a photo-polimerizable compound, due to the transparency of the materials H of zirconium or compound and/or polimerizable, as shown in FIGS. 19, 20 and 21. Thus a mono-block is formed of the walls of the plant, the compound and the pin out of zirconium fibre. The compound and the pin will project over the edges of the funnel-shaped walls shown in FIGS. 10, 20 and 21, that will lie inside the mucosa and that will just project from the part opposed to fixture X shown in FIGS. 16, 17 and 18, so as to form the stump realized by the dentist himself in the mouth of the patient, and projecting like the stump of a natural filed tooth, so that it will be as suitable as ever possible to that situation of angulation between the crown and the axis of the plant and the inter-dental distance. In this way, the plants may be personalized. The plant must be inserted in such a way that the funnel-shaped stump projects from the mucosa; the part of the fixture will be inserted into the bone up to the neck W, as shown in FIGS. 16, 17 and 18, which is a passage area between titanium and baked clay in the outer part. The titanium fixture and the baked clay are mechanically linked as shown in G of FIGS. 10, 12 and 14 in a screwing and, as a hollow area, made or shaped inside the titanium of the fixture. The substance out of which the stump is made will cover said groove D, for a thickness suitable to the resistance of the structure and to the diameter of the fixture, e.g. one millimetre. The walls of the groove may be parallel or slightly diverging as in H′ of FIGS. 10, 12 and 14, so as to assure a greater mechanic retention of the material forming the funnel-shaped stump. Said structure may also have holes in the walls as well as in the bottom, or notches or other cuts for increasing the retention of the baked clay or of the compound or of any other material forming the titanium stump or fixture. The length of the groove into which the material gets inserted with which the funnel of the stump is realized—e.g. zirconium—coating the titanium of the fixture in its internal hollow part, must be suitable for the retention and solidity of said material, e.g. 4 millimetres, and must be determined together with the maker. The point of passage between the metal and said material forming the stump, in the direction of the bottom of the hollow, must be clean so that one material rests onto the other like a step, as shown in F of FIGS. 10, 12 and 14, so that the baked clay does not break under the load. The internal surfaces of the hollow may be preferably made in such a way that there is not continuity solution and that they appear to be continuous, as shown in E of FIG. 10: this will allow an easy insertion of the key out of titanium or steel or any other suitable material inside the hollow that will be used for screwing the plant into the bone.

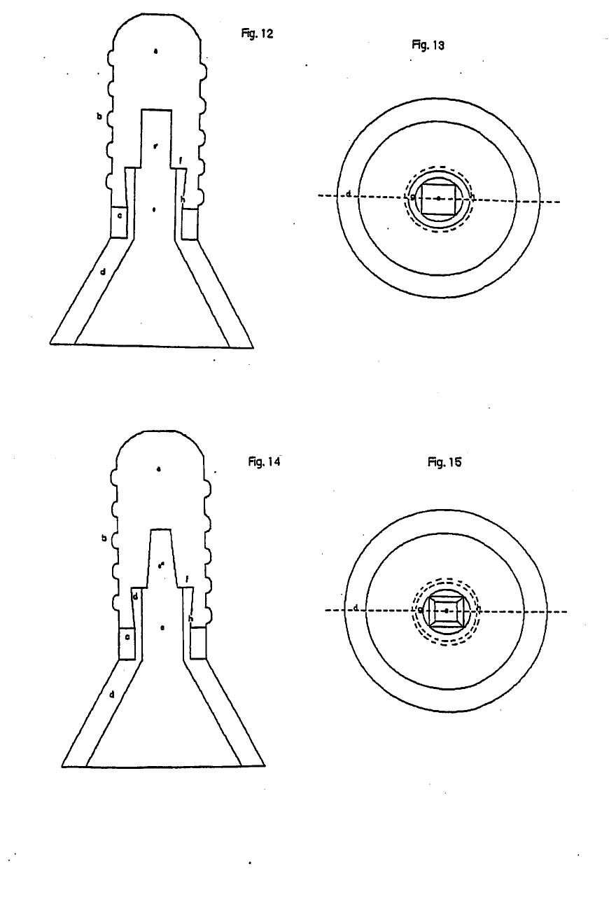

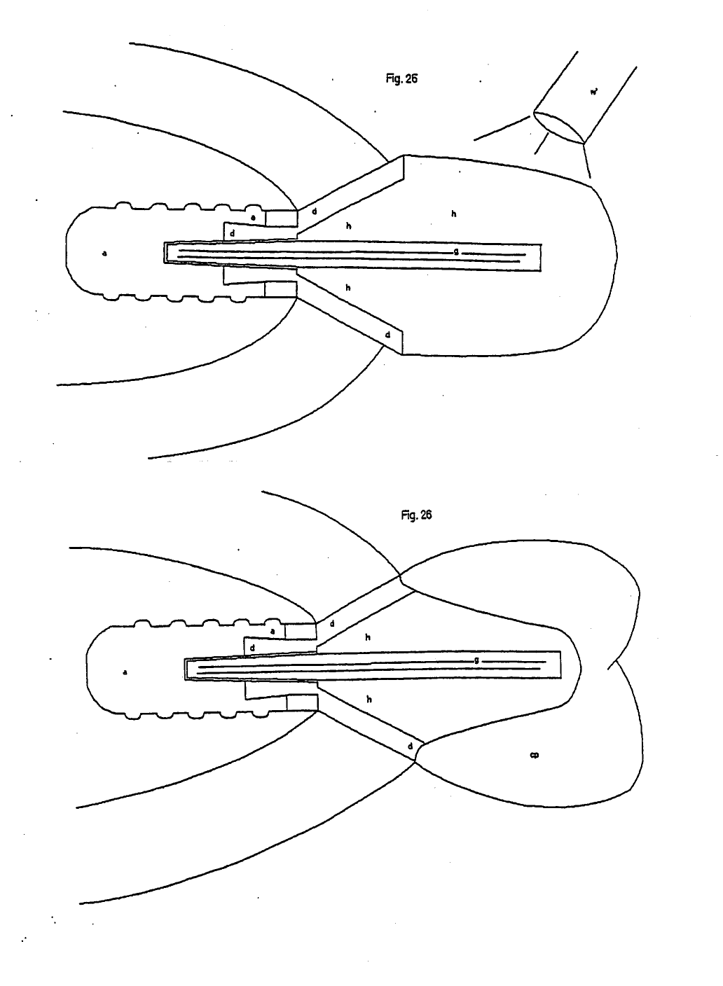

In a variant, the internal surfaces of the hollow may also have a cylindrical shape for ending up in a parallelepiped with a square base E′ as shown in FIG. 12, or the shape of a pyramid with a square base E″ as shown in FIG. 14, with the greater base—in the case of the pyramid with square base—inscribed in the apical circular base of the hollow cylinder, which is an area for the insertion of the stem of the key or mandarin of FIGS. 23 and 24, and preferably it will have titanium walls so that the forces applied there won't produce a fracture of the walls of the funnel-shaped stump, out of zirconium of a more fragile compound. The key working as the male element must be inserted into the hollow that works as the female element. The key may have the shape of a parallelepiped Y with a square base, as shown in FIG. 23, or, even better, the shape of a pyramid K with a square base, as shown in FIG. 24, or a shape similar to the one of the hollow into which it will be inserted, but having dimensions slightly smaller than the latter, so as to allow an easy insertion and removing, still in consideration of a retention suitable for the screwing of a plant. The key consists of a stem and of a head. The stem has the function of getting inserted from inside in the hollow of the fixture for screwing the same into the bone, and it may have the shape of a parallelepiped Y with a square base as in said FIG. 23, or it may end up in the truncated cone of a pyramid with a square base, wherein the minor square base provided at the end thereof will get into contact with the bottom of the hollow in the insertion manoeuvres.

The stem in the shape of a parallelepiped with a square base K′, shown in FIG. 24, ending up in a truncated cone of a pyramid, is to be preferred, because it facilitates the insertion and removing manoeuvres. In case of greater force applied during the screwing operation, as it may happen in the presence of a compact, hard bone, the risk of fusion between the surfaces of the stem and may be avoided, as a pyramid-shaped body inserted into a similar hollow is much easier to be removed than a body with the shape of a parallelepiped inserted into a similar hollow, the parallel surfaces whereof might cause it to get stuck into it. The shape of a pyramid truncated-cone also suits better to the morphology of the fixture: in the case of a conical plant, it allows to have a suitable titanium thickness around the truncated-cone pyramid hollow, in the direction of the smaller surface: in such area, a hollow in the shape of a parallelepiped would make the walls too thin, especially in the fixtures with a small diameter.

According to the present invention, at the opposite side there is the head of the key T shown in FIG. 24, greater and of such a shape—e.g. cubic or cylindrical—as to allow the insertion of a ratchet that favours the screwing manoeuvres—manual or with a suitable support for the counter-edge—of the plant. The dimensions of the key may be different: the stem may be 2.5 cm, 2 cm, 1.5 cm long or may have other length, so as to favour the insertion of the plant in areas difficult to reach; the thickness of the stem may vary: suggested is a thickness of 1 mm or 1.5 mm as a side of the base square of the parallelepiped forming it, or 2 mm for the side of the major base and 1 mm for the side of the minor base of the truncated cone pyramid; the head may have a radius of 3 mm or other dimensions which may better suit it to the shape of the ratchet that is to be used, and more precisely to the one of the ratchet's hole where the head of the key is housed.

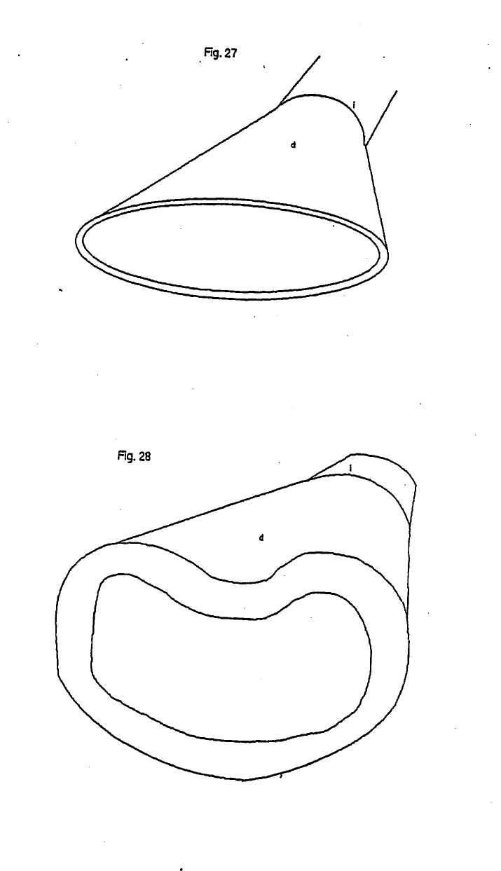

The variant of the hollow plant is useful in the cases of the non alignment between the axis of the fixture and the axis of the crown: the funnel-shaped stump allows the dentist to polimerize with a lamp of the kind of the lamp W′ shown in FIG. 25, or with an self-polimerizing compound, the compound inside it, so that a mono-block is formed between the outer part of the stump D of FIG. 25—out of zirconium or compound or other suitable material—the compound H, the pin G out of zirconium fibre, and the metal of the fixture A. If it will be decided to make the stump immediately, in fact, the outer part of the funnel D of fixture A will get into contact with the tissues lesioned by the operation, therefore bleeding and exuding, and therefore said part will be protecting the polimerization occurring inside from the fluids, however present. Once the compound has been polimerized, and once the dentist has suitably adapted it to the mouth of the patient so as to form a stump of suitable dimensions, it will be easy to file it to make it ready for taking a print for realizing a crown, preferably out of compound or integral baked clay. The result will be a work of high aesthetic value. If there is primary stability of the fixture, the whole operation may be performed in a few hours and the patient will be able to make use ot the plant in little time. Time may be considerably reduced if the dentist may use a mechanized computer system, like the Cerec III Cad Cam, for the realization of the crown. If the dentist is a skilled one, he may realize the crown CP shown in FIG. 26 himself, out of compound, or even realize again the crown out of compound directly in the mouth of the patient: it will make easier the choice of the colour and the correct disposition of the layers of the masses. If there is no primary stability, it will be advisable to differ said process for the time necessary for the integration of the bone, using the funnel as a recovering screw or as a trans-mucous plant: the edges of the funnel will be filed with a cutter mounted onto a turbine TB as shown in FIG. 18, rounding them off for making them fitting to the gingiva and not cutting or troublesome, and then the concave part of the funnel will be sealed with provisory filling material PR shown in FIGS. 16 and 17, and then proceed, in the right moment, to the realization of the stump, projecting from the gingiva, and of the corresponding crown. This is the primary indication for the use of the hollow variant because if there is no primary retention, the plant may be inserted all the same and no noxious intra-oral forces—like chewing or bruxing—may act on the same, destabilizing it: on the contrary, the plant will be protected inside the bone and the gingiva, surfacing from the same, so as to postpone to the moment of its bone integration the reconstruction phase of the stump and of the crown and therefore of the load.

For better fitting to the anatomy of the natural teeth, the funnel-shaped stump may have different shapes: the section perpendicular to its long axis may be round for canines, premolar, the lower incisors and the molars; elliptical, as shown in FIG. 27, for the upper incisors, or even of the most suitable shape for simulating the roots of the molar teeth as shown in FIG. 28. This may be done because the part that will be inserted into the bone, i.e. the fixture, is always maintained in a cylindrical or conic shape and therefore always keeps its screwing feature, while the trans-mucous funnel-shaped part may assume different shapes, as similar as possible to the anatomy of natural teeth, because the soft tissues oppose no resistance and impediment to the circular screwing motion necessary for the insertion thereof. The same operation may be performed in the VP, with the stump.

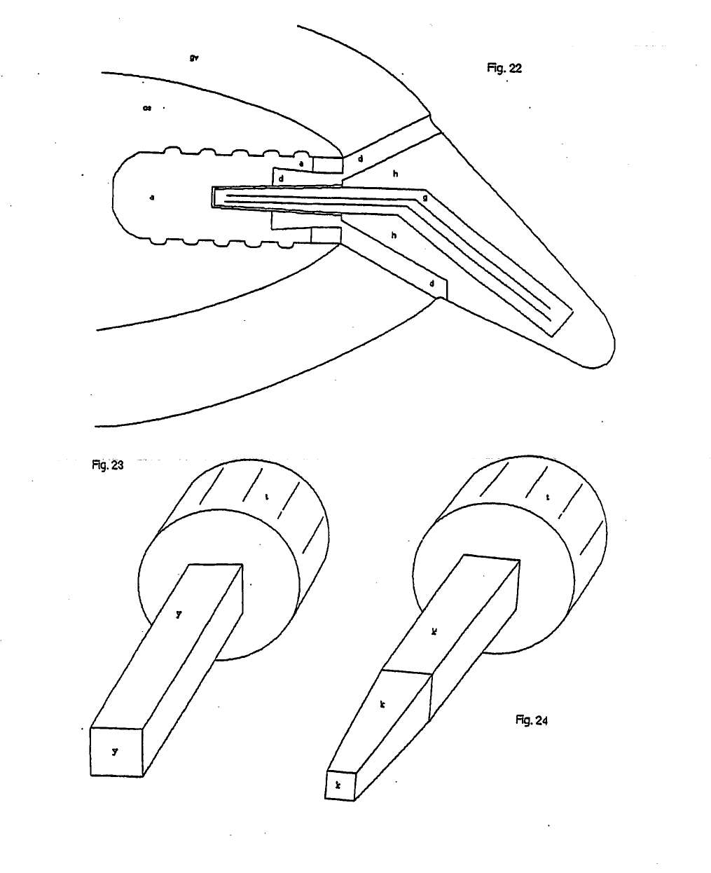

A further element of the plant according to the present invention consists of a fibre pin G, e.g. out of zirconium, bent or angled as shown in FIG. 22, for keeping the core H of the compound shown in FIG. 22 for forming the stump projecting into the oral cavity: this is necessary when there is a strong angulation between the axis of the fixture and the one of the crown to be reconstructed. The pin must be out of zirconium or glass fibre, out of compound or other suitable material, of cylindrical shape but bent in the centre: many different pins may be made with different angulation: 10°, 15°, 20°, 25° and 30° so as to meet the most different needs. Even if it is conical, it is still bent at about half its length. The conical pin better fits the anatomy of natural teeth, as it requires less dentine sacrifice in the apical portion of the roots. It may also have the shape of a parallelepiped with a square base, bent at the half of its length, and end up in the shape of a truncated-cone pyramid with a square base, so as to get stuck in the hollow of the mono-block plant VC being its homologue print, already offering a primary retention. Each shape will have a standard length, e.g. 1.9 centimetres, and it will be easy to cut it at its ends with a cutter mounted onto a turbine, for fitting it to the system. Said pin may be used also in the roots of natural teeth for reconstructing the stump thereof.

1-14. (canceled)

15. A dental plant comprising
a stump prepared in advance, united to a body of the plant that is inserted into the bone; said stump having a truncated cone shape inserted into said body of the plant to shape the same stump, directly in the mouth and with the help of a preparation cutter mounted onto a turbine, at a predetermined inclination for the prosthesis rehabilitation.

16. A dental plant according to claim 15, wherein said body of the plant and said stump consisting of one single piece-mono-lithe or mono-block.

17. A dental plant according to claim 15, wherein said body of the plant presents cylindrical or conical shape to be inserted into a hole provided in the bone, said body also presenting turns to screw the plant, until the stump reaches the edge of the bone crest.

18. A dental plant according to claim 17, wherein said turns present a rough surface for improving the bone integration, and said turns end up in a smooth area of a neck, of variable length, preferably of 2 millimetres and of cylindrical shape; said stump consisting of a first trans-mucous part, cylindrical or of an upside-down truncated-cone, or has the shape of a pressed funnel, and a second part, in the shape of a truncated-cone turned upside-down.

19. A dental plant comprising
a stump partially realized, united to a body of the plant that is inserted into the bone; said stump having a truncated cone shape inserted into said body of the plant and presenting a funnel shaped shell and a pin disposed inside the shell, out of zirconium fibre and with a polimerized compound.

20. A dental plant according to claim 19 wherein it is disposed partially submerged just surfacing form the mucosa; said stump having an axis coinciding or angled with respect to the one of the plant.

21. A dental plant according to claim 19, wherein said body of the plant and said stump consisting of one single piece-mono-lithe or mono-block.

22. A dental plant according to claim 19, wherein said pin is bent with respect to the axis of the plant.

23. A dental plant according to claim 19, wherein the stump is made of zirconium or compound or other aesthetic and/or transparent material, hollow inside like a funnel thus allowing the insertion inside the same of a transparent pin, out of zirconium fibre, cemented with a photo polimerizable or a self-polimerizing compound, and due to the transparency of the components, forming a mono-block between the walls of the plant-compound and pin out of zirconium fibre so that said compound and said pin project beyond the edges of the funnel-shaped walls which just surface from the mucosa, to form a stump projecting like the stump of a natural filed tooth.

24. A dental plant according to claim 19, wherein comprises inner surfaces of the hollow having the shape of a cylinder and ending up in a parallelepiped with a square base, or in a pyramid with a square base, with the greater base-in the case of the pyramid with the square base inscribed in the circular apical base of the hollow cylinder, which is an area for the insertion of the stem of a key or mandarin in the shape of a parallelepiped with a square base or of a truncated-cone pyramid with a square base.

25. A dental plant according to claim 24, wherein said key is formed by a stem having the function of insertion inside the hollow of the fixture for screwing it into the bone, and by ahead cubic or cylindrical for allowing the insertion of a ratchet for the screwing manoeuvres of the plant, manual or with a suitable support for counter-angle.
